(19) United States
(12) Patent Application Publication
(10) Pub. No.: US 2017/0274819 A1
(43) Pub. Date: Sep. 28, 2017

(54) Hazard Triangle

(71) Applicant: Joseph F. Domingo, Elmhurst, IL (US)

(72) Inventor: Joseph F. Domingo, Elmhurst, IL (US)

(21) Appl. No.: 15/614,162

(22) Filed: Jun. 5, 2017

Related U.S. Application Data
(63) Continuation-in-part of application No. 15/456,217, filed on Mar. 10, 2017.
(60) Provisional application No. 62/311,680, filed on Mar. 22, 2016.

(51) Int. Cl. B60Q 7/00; E01F 9/654; E01F 9/623; B60D 1/58; G09F 13/28

(52) U.S. Cl. CPC B60Q 7/00; B60D 1/58; G09F 13/28; E01F 9/623; E01F 9/654; G09F 13/16

(57) ABSTRACT

A hazard triangle includes a triangular shaped body formed of a transparent or semi-transparent material having a thickness and three sides, one of which is a proximal edge. The thickness is substantially less than a length of any of the three sides. An illumination element is configured to emit light into the proximal edge. The emitted light is propagated by the body such that light is emitted from surfaces of the body other than the proximal edge.

### RELATED APPLICATION DATA

This patent is a continuation-in-part of, and claims priority benefit of, U.S. application Ser. No. 15/456,217 filed Mar. 10, 2017 and entitled “Lumen Wand”, and which claimed priority to U.S. provisional application Ser. No. 62/311,680 filed Mar. 22, 2016 and entitled “Marshalling Wand.” The entire contents of these prior filed applications are hereby incorporated herein by reference.

### BACKGROUND

1. Field of the Disclosure

The invention is generally related to hazard triangles, and more particularly to an illuminated hazard triangle.

2. Description of Related Art

Hazard triangles are known in the art. Hazard triangles are often used by motorists having difficulties with their vehicle to warn other motorists in oncoming traffic. Truck drivers, law enforcement, highway safety personnel, and the like often deploy such hazard triangles.

A conventional hazard triangle is often made of an orange or other brightly colored plastic material. Reflectors or a reflective coating is sometimes attached to the body of the triangle. The reflective material can make the hazard triangle visible at night by reflecting light from the headlights of approaching or oncoming vehicles.

When a vehicle approaches a conventional reflective hazard triangle, reflection will not occur when the angle of incidence of light from the headlights is such that the light no longer strikes the triangle. At this point, the driver of an oncoming vehicle will no longer see a conventional hazard triangle at night. A curved road will further exacerbate this issue. Further, such reflective triangles are not visible at night by pedestrians and others where there are no headlights or other light striking the hazard triangle.

Others have tried to address these and other problems with known hazard triangles. Hazard triangles have been developed that use an illumination or light source to illuminate the hazard triangle. See, for example, U.S. Pat. No. 5,349,346. The solution proposed in the '346 patent may be deficient due to excessive power consumption and the complexity of repairs and maintenance. The user may have difficulty in keeping such a prior known device in proper operating condition due to the numerous LED's, which can fail and would need to be replaced.

### SUMMARY

In one example, according to the teachings of the present disclosure, a hazard triangle includes a body having a triangular shape formed of a transparent or semi-transparent material. The body has a thickness and three sides, one of the three sides defining a proximal edge of the body. The thickness of the body is substantially less than a length of any one of the three sides. An illumination element is configured to emit light into a proximal edge of the three sides. The emitted light is propagated by the body such that light is emitted from surfaces of the body other than the proximal edge.

In one example, the hazard triangle can have a power source disposed within a housing.

In one example, the hazard triangle can have a power source that includes a rechargeable battery. The rechargeable battery can be disposed within the housing.

In one example, the illumination element can be located near at least one corner of the body on the one side.

In one example, the illumination element can have two light sources. Each light source can be located near a different corner of the body on the one side.

In one example, the illumination element can include a LED as a light source.

In one example, the proximal edge can be adjacent the illumination element. A portion of the proximal edge can be curved concavely relative to the illumination element to direct the emitted light from the illumination element in a plurality of directions into the body.

In one example, the illumination element can include a lens disposed between the proximal edge and a light source of the illumination element. The lens can be concave relative to the light source.

In one example, the hazard triangle can include a switch disposed within a housing. The switch can be configured to operate the illumination element.

In one example, the hazard triangle can include an actuation mechanism. The actuation mechanism can have a switch, which can be coupled to an actuator that can be exposed to an exterior surface of the housing.

In one example, the hazard triangle can include a microprocessor, which can be disposed within a housing. The microprocessor can be operably connected to the illumination element.

In one example, the body can be formed of a solid acrylic material.

In one example, at least a front surface and a rear surface of the body can be modified to control an amount of the light emitted therefrom, a direction of the light emitted therefrom, or both the amount and the direction of the light emitted therefrom.

In one example, two sides of the three sides of the body, other than the proximal edge, can be modified to control the amount of the light emitted therefrom, the direction of the light emitted therefrom, or both the amount and the direction of the light emitted therefrom.

In one example, an applique layer of material can be applied to the front surface and the rear surface of the body. The applique layer can be configured to omnidirectionally disperse the light emitted therefrom.

In one example, a 3M Diamond Grade Reflective Fluorescent Orange applique material can be adhered to the body.

In one example, an applique layer, a coating, or a surface texture can be applied to at least a portion of the front surface and the rear surface of the body.

In one example, the body can be formed of two layers of material joined to one another. A surface of each of the two layers can be etched. The etched surface of each layer can be an internal layer that faces the other.

In one example, at least one support stand can be coupled to the proximal edge of the body.

In one example, at least one support stand can be coupled to the body and can rotate about an axis between a stored position parallel with the body and a support position not parallel with the body. The support position can be configured to hold the body upright.

In one example, at least one support stand can be coupled to the body. The support stand can be configured to hold the body upright. The support stand can have a slot in which the proximal edge can be seated.

In one example, the illumination element can be housed within a portion of the support stand.

In one example, the hazard triangle can include: a) a microprocessor disposed within a housing, the microprocessor configured to control one or more functions of the hazard triangle; b) a USB port carried by the housing; c) a charging chip disposed within the housing; d) a rechargeable battery disposed within the housing, the charging chip configured to control at least one aspect of recharging the rechargeable battery, the USB port configured to connect to a source of power to recharge the rechargeable battery; e) an actuation mechanism disposed at least in part within the housing, the actuation mechanism configured to control the illumination element; and f) a lens disposed between a light source of the illumination element and a portion of the proximal edge of the body.

In one example, the hazard triangle can have a magnetic component configured to magnetically adhere the hazard triangle to a second hazard triangle of like construction.

In one example, the body can have a central triangular opening within and spaced inward from the three sides.

In one example, the hazard triangle and at least one support stand each can comprise at least one magnetic component. The magnetic components can be configured to magnetically connect and retain the body to the at least one support stand in at least a stored position.

In one example, the body can be a solid material layer with no central opening.

In one example, according to the teachings of the present disclosure, a signaling device includes a body formed of a transparent or semi-transparent material with a thickness and a perimeter. A portion of the perimeter defines a proximal edge. An illumination element is configured to emit light into the proximal edge of the perimeter. The emitted light is propagated by the body such that the emitted light is emitted from surfaces of the body other than the proximal edge.

In other examples, the aforementioned features and aspects of the hazard triangle may be incorporated as a part of the signaling device alone or in any combination.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a hazard triangle constructed in accordance with the teachings of the present disclosure, the hazard triangle shown in a standing configuration.

FIG. 2 shows a front plan view of the body of the hazard triangle shown in FIG. 1.

FIG. 3 shows a perspective view of another example of a hazard triangle constructed in accordance with the teachings of the present disclosure, the hazard triangle shown in a standing configuration.

FIG. 4 shows a front plan view of the body of the hazard triangle shown in FIG. 3.

FIG. 5 shows a simplified schematic view of one example of an illumination element and electronic components of the hazard triangles of FIGS. 1 and 3.

FIG. 6 shows a cross-section taken along line 6-6 of the body of the hazard triangle of FIG. 4.

FIG. 7 shows a cross-section of another example of a body of a hazard triangle in accordance with the teachings of the present disclosure, the body having two layers of material shown prior to being joined to one another.

FIG. 8 shows the body of a hazard triangle of FIG. 7 with the layers of material joined to one another.

FIG. 9 shows a perspective view of two of the hazard triangles of FIG. 1 and shown in a stored or storage configuration attached to one another for combined storage.

FIG. 10 shows a perspective view of another example of a hazard triangle constructed in accordance with the teachings of the present disclosure and shown in a storage configuration.

FIG. 11 shows the hazard triangle of FIG. 10 but in a standing configuration.

FIG. 12 shows a perspective view of two of the hazard triangles of FIG. 10 and shown attached to one another for combined storage.

FIG. 13 shows a perspective view of another example of a hazard triangle constructed in accordance with the teachings of the present disclosure and shown in a storage configuration.

FIG. 14 shows the hazard triangle of FIG. 13 but in a standing configuration.

FIG. 15 shows a perspective view of two of the hazard triangles of FIG. 13 and shown attached to one another for combined storage.

FIG. 16 shows a perspective view of another example of a hazard triangle constructed in accordance with the teachings of the present disclosure.

FIG. 17 shows a perspective view of another example of a hazard triangle constructed in accordance with the teachings of the present disclosure.

### DETAILED DESCRIPTION OF THE DISCLOSURE

This disclosure is generally related to warning, marshalling, and signaling devices. In one example, a signaling device according to the present disclosure can include a body that is formed of a transparent or semi-transparent material with a thickness and a perimeter. A portion of the perimeter defines a proximal edge. The thickness can be substantially less, such as two or three times less, or preferably still less, than a length, width, or other body dimension that is orthogonal to the perimeter edge. The effect is to produce a generally flat or planar body. The signaling device also has an illumination element configured to emit light into the proximal edge of the perimeter. The emitted light is propagated by the body such that the emitted light is emitted from surfaces of the body other than the proximal edge.

In the examples disclosed in the above-noted prior application, U.S. Ser. No. 15/456,217 (incorporated herein by reference in its entirety), the signaling device is a marshalling wand, such as those used by airport personnel to direct air traffic on the ground. In the instant application, the signaling device is a hazard warning device, such as a hazard triangle used by motorists on the road to warn other drivers of a disabled vehicle.

The disclosed hazard triangles solve or improve upon one or more of the above-noted and/or other problems and disadvantages with prior known hazard triangles. In one example, the disclosed hazard triangles utilize a triangular shaped body that incorporates an illumination element with a light source. The illumination element, including the light source, can be provided within a housing coupled in some way to the body. The light source can be a long lasting, low power consumption LED or other suitable light emitting element. Light is emitted from the light source into an edge of the triangular body, whereby the light propagates along the interior of the triangular body to be emitted from the other side edges and the front and rear surfaces of the triangular body. In one example, the various surfaces of the triangular body can be treated or modified to control and/or enhance the light emitted from the triangular body. These and other objects, features, and advantages of the disclosed hazard triangles will become apparent to those having ordinary skill in the art upon reading this disclosure.

Turning now to the drawings, FIG. 1 shows one example of a hazard triangle 20 constructed in accordance with the teachings of the present disclosure. In this example, the hazard triangle 20 has two support stands 22 coupled to a body 30, the body having a triangular shape. The body 30 can be formed having a relatively thin thickness and has three corners including a top corner 28 and two bottom corners 32. The body 30 also has front and rear surfaces 34, 36 and three sides including two sides or side edges 38, 40 and a proximal edge 44. In this example, the two side edges 38, 40 extend between the top corner 28 and a respective one of the bottom corners 32 and the proximal edge 44 extends between the bottom corners 32. The front and rear nomenclature is used herein solely to differentiate one from the other as either surface could be considered the front or the rear surface. In this example, the top corner 28 is rounded and the bottom corners 32 are sharp, though this shape can vary for any of the corners.

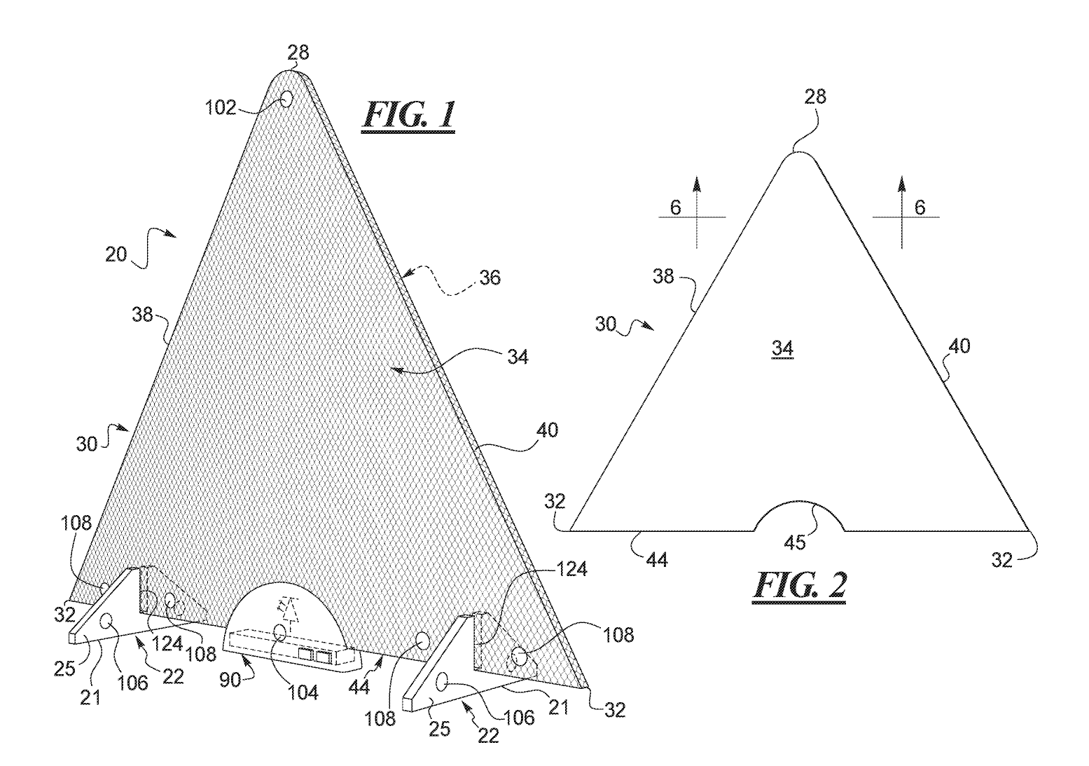

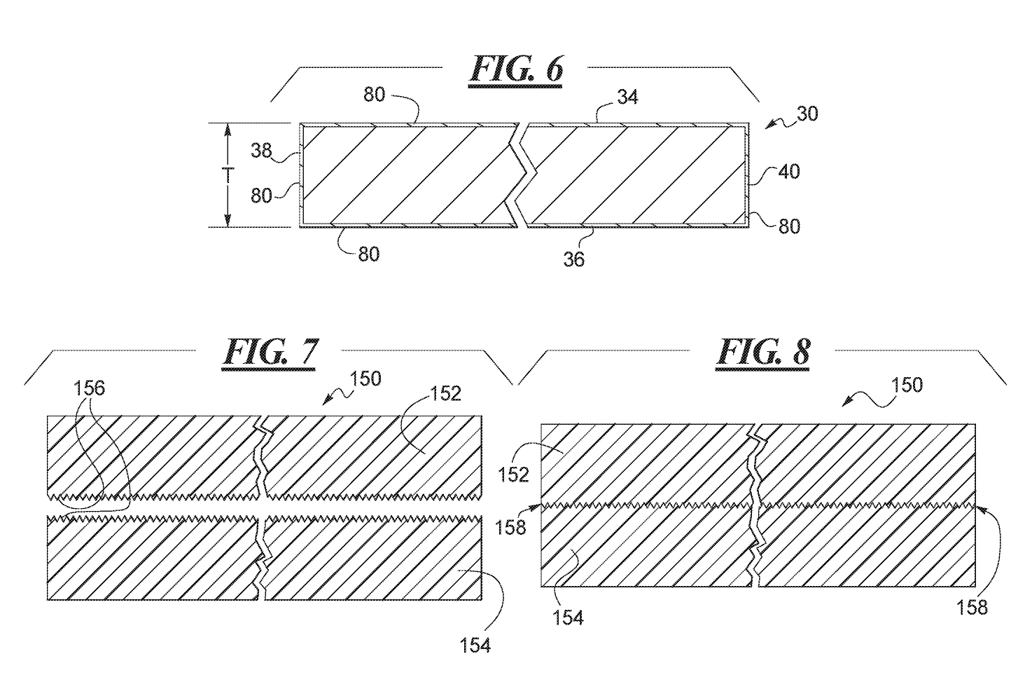

In one example, as shown in FIG. 2, the body 30 is essentially a solid piece of material from corner to corner 28, 32 and between the front and rear surfaces 34, 36. The body 30 can be made of a non-colored, clear, i.e., transparent plastic material such as acrylic. In other examples, the material can be a light specific material, i.e., a higher-grade plastic or other material designed with particular light refracting and propagating characteristics tuned to the proportions, and particularly the thickness T (see FIG. 6), of the body 30. The material of the body 30 need not be colorless, clear or transparent. Instead, the material can have a color or tint, such as orange, yellow, or red, and/or can be translucent to some degree. The body 30 may be made, for example, from transparent orange acrylic, translucent orange acrylic, fluorescent orange acrylic, or the like. The color, if any, need not be orange. The material need not be acrylic. If acrylic, the specific type and/or properties of the acrylic material can also vary. Also, depending on the intended application for the hazard triangle 20, the material of the body 30 may have a blue tint, a yellow tint, a red tint, an orange tint, a green tint, or the like.

In general, the hazard triangle 20 is constructed so that, when it is illuminated, light is emitted from at least the front and rear surfaces 34, 36 of the body 30. The hazard triangle 20 can also be constructed so that light is emitted from the two exposed sides or side edges 38 and 40 of the body. As described below, the surfaces on the body 30 of the hazard triangle 20 can be provided with characteristics and/or features that help to more evenly distribute the emitted light over the surfaces of the body 30.

The support stands 22 of the hazard triangle 20 in this example are configured to attach to or be mounted on the proximal edge 44, as shown in FIG. 1. In this example, the supports stands 22 can be positioned near the bottom corners 32 to provide a stable base to support the hazard triangle 20 in an upright position for use, as depicted in FIG. 1. Each support stand 22 can be made having a support plate 25 with a slot 24 that can be sized and oriented to receive the proximal edge 44 of the body 30. The support plate 25 of the support stands 22 may have a triangular shape with a relatively thin thickness and a bottom surface 21. The shape and thickness can vary from the disclosed triangular shape illustrated in FIG. 1. The support stands 22 can also be formed of any suitable material or combinations of materials. For example, the support stands 22 can be made from inexpensive plastic materials, rubber materials, or combinations thereof. The bottom surface 21 of the support plates 25 can include a texture to improve friction, if desired. Alternatively, the support stands 22 can be formed having a substantially rigid inner support plate, such as a hard plastic, the plate being covered by a softer outer layer of material.

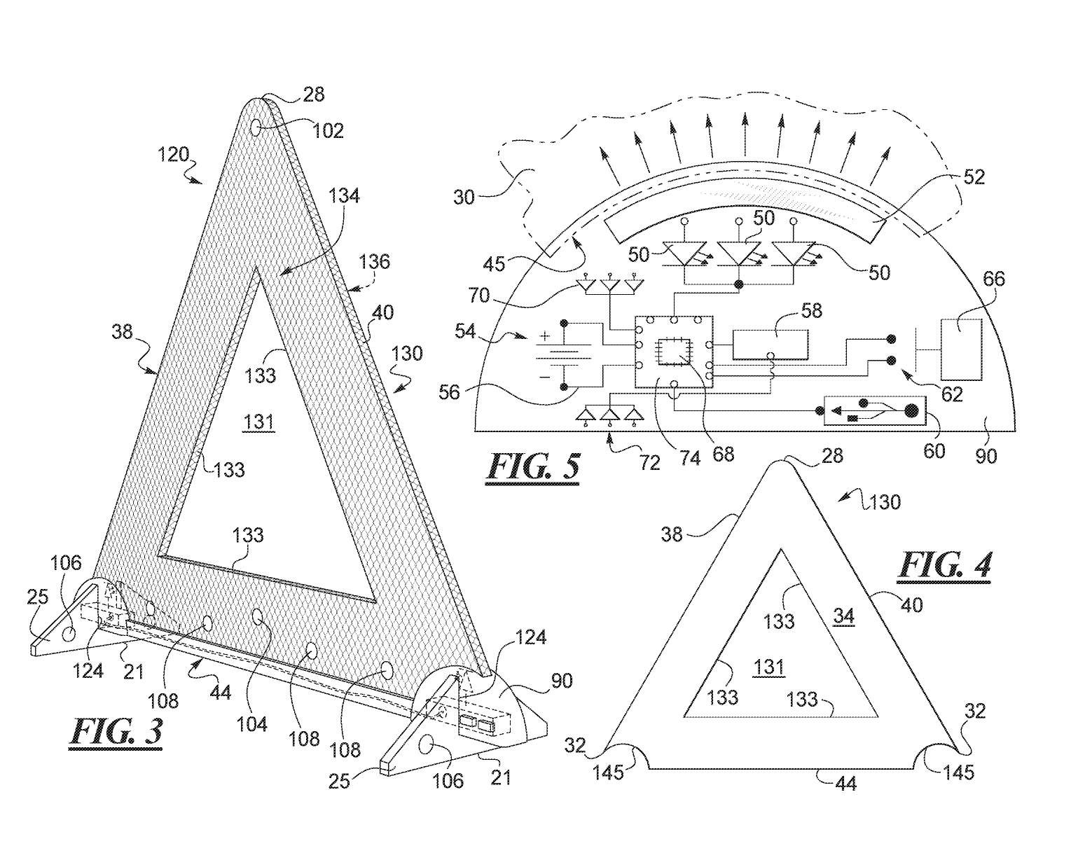

FIGS. 3 and 4 show another example of a hazard triangle 120 constructed in accordance with the teachings of the present disclosure. In this example, the hazard triangle 120 has two support stands 122 coupled to a body 130, which also has a triangular shape. The body 130 in this example can also be formed having a relatively thin thickness and have the same three corners including a top corner 28 and two bottom corners 32. The body 130 also has front and rear surfaces 134, 136 and has the same three perimeter or outer sides, including the exposed two sides or side edges 38, 40 extending between the top corner 28 and respective bottom corners 32, and the proximal edge 44 extending between the bottom corners 32. However, in this example, the body 130 also includes a triangular shaped central opening 131 on the interior of the body. In this example, the opening 131 is defined within interior or inner edges 133 spaced inward from respective ones of the side edges 38, 40, and the proximal edge 44. The material and other features of the body 130 for the hazard triangle 120 can otherwise be the same or similar to those described above for the body 30 of the hazard triangle 20.

The support stands 122 of the hazard triangle 120 in this example can be substantially the same as the support stands 22 described above for the hazard triangle 20. Thus, the support stands 122 can include a support plate 25 with a bottom surface 21, as described above. The support plate 25 can also include a slot 124 for receiving the proximal edge 44 of the body 130, also as described above. However, in this example, the slot 124 is wider to accommodate another feature of this hazard triangle 120 example. The size, shape, material, and other features of the support stands 122 for the hazard triangle 120 can otherwise be the same or similar to those described above for the support stands 22 of the hazard triangle 20.

The hazard triangle 20 in this example, as depicted in FIG. 1, includes illumination and electrical components to illuminate the body 30. FIG. 5 shows a simplified schematic representation of the illumination and electronic components of the hazard triangle 20. In this example, these components are housed within a housing 90 that is coupled or attached to the body 30. To house, retain, and protect these components, the housing 90 can include a hard, plastic shell with a hollow interior cavity within the shell.

Referring to FIGS. 1 and 2, the housing 90 can be attached to the proximal edge 44. In this example, the proximal edge 44 has a curved notch 45 indented or formed concavely into the proximal edge and located at a midpoint between the bottom corners 32. The housing 90 can be positioned adjacent the curved notch 45 such that the curved notch faces into the cavity of the housing.

The housing 90 in the disclosed example houses components to illuminate and operate the hazard triangle 20 and to provide additional functionality for the hazard triangle. In this example, as depicted in FIG. 5, the hazard triangle 20 has an illumination element with at least one light source housed within the housing 90. The light source can include or can be a light bulb or the like. The light source is positioned and directed to emit light into the body 30, as described further below. In one example, the light source can include or can be one or more light emitting diodes (LED) 50. FIG. 5 depicts three such LED's, although a single LED may certainly suffice. LED's are long lasting, are energy efficient, can be quite small yet powerful, and can produce a consistent light output. However, other types of light sources may certainly be used, if desired. In general, the emitted light enters the body 30 via the curved notch 45 and propagates along and through the body 30. Light is then emitted from surfaces and edges of the body 30, other than the proximal edge 44, as discussed further below.

The hazard triangle 20 in this example includes the illumination element with the light source, such as the LED or LED's 50. is the illumination element is positioned adjacent the curved notch 45 but within the housing 90. The cavity of the housing 90 can be configured to securely hold and retain the LED's 50 in the desired position. Each of the LED's 50 may be a blue LED, a white LED, an RGB LED, and RGBW LED or other type of LED, as needed to produce a desired color or brightness. Other types of light sources for the illumination element may also be used, as noted above.

In this example, each LED 50 is positioned to direct light toward and into the curved notch 45 of the proximal edge 44 of the body 30. The curved notch 45 may be optimally and concavely curved to create a lens function that may shape, disperse, radiate, or otherwise direct the light into the interior of the body 30. Alternatively, or in addition, the illumination element may include a separate lens 52 that is deployed between the LED's 50 and the curved notch 45 of the proximal edge 44 of the body 30. The lens 52 may be provided to more precisely or specifically shape the light exiting the lens and entering the body 30 via the curved notch 45. Light emitted from the LED's 50 thus enters the curved notch 45 of the proximal edge 44. The curvature of the notch 45 and/or the lens 52 can direct light evenly over the surface of the notch and into the body 30 in a plurality of directions. The direction of each beam of light may be determined by the angle that each beam exits the LED's 50 and by the angle that each beam exits the lens 52, if provided. The direction of each beam of light may also be determined by the angle of incidence fort each beam hitting the surface of the curved notch 45. The direction of each beam of light may also be determined by the degree that each beam of light is reflected and/or refracted upon entering and propagating within the body 30. Thus, the light emitted by the LED's 50 can be evenly distributed in multiple directions within the body 30.

In other examples, the illumination element and/or light source can be located separate from or outside of the housing 90, such as in another component located between the hazard triangle 20 and housing 90, or elsewhere on the hazard triangle, if permissible by the design and if desired. The illumination element and/or light source can emit white light or can emit colored light, such as blue light, orange light, yellow light, red light, green light, or the like as well. The intended application for the hazard triangle 20, as well as the tint or lack thereof of the body 30, may dictate the color of light to be emitted by the light source.

The hazard triangle 20 in this example also has a power source 54 that is configured and arranged to provide energy to illuminate the LED's 50. In one example, the power source 54 can be or can include a battery 56, such as a DC battery, a rechargeable battery, or the like. The battery 56 in this example, or another power source 54, can be housed in a separate compartment within the cavity of the housing 90. If desired, the battery 56 can be accessible by removing a portion of the housing 90, such as a battery door (not shown), to recharge or replace the battery as needed. Other types of batteries 56 may also be used and the power source and/or battery also need not be housed within the housing 90. The power source or battery can instead be carried elsewhere on the hazard triangle 20 or all or part of the power source can be provided remote from the hazard triangle.

In the disclosed example, the power source 54 includes a charging chip 58 coupled to the battery 56. The charging chip 58 can be programmed or configured to apply various algorithms or protocols to the battery 56. The battery 56 in this example can be of the type that stays within the housing 90 and thus does not need to be removed in order to be recharged. Thus, in this example, the power source 54 can also include a universal serial bus (USB) port 60 or other type of connection port that is provided on the hazard triangle 20. For example, the USB port 60 access opening (though not depicted herein) can be an accessible port on a side of the housing 90. One purpose of the USB port 60 can be to connect a charging cord to the USB port to recharge the battery 56.

The battery 56 can be of any suitable type. In some examples, the battery 56 can be a nickel-cadmium (NiCad) battery, a nickel-metal hydride (NiMH) battery, a lithium-ion (Li-ion) battery or the like, each having different charging and power dissipation characteristics. The charging chip 58 can be configured to include a protection circuit, which might typically be required to safe charge a Li-ion battery. The charging chip 58 may also regulate current and voltage, may include field-effect transistor (FET) switches to control or stop current, and may provide charge status indicators and/or battery cell balancing. The charging chip 58 may also have a time-out-timer feature that stops a charge of a defective battery, if predictable symptoms do not occur as expected during charging. The charging chip 58 may also be configured to offer pre-charge conditioning or boost to wake an inactive battery. The charging chip 58 also may offer a sleep mode that reduces the current of the circuit for the power source 54 while the battery 56 and hazard triangle 20 are in storage. The charging chip 58 can be configured to open the charging circuit after the battery 56 is fully charged but before the battery is disconnected from a charger. The charging chip 58 may also be configured to provide an indication of remaining battery charge, remaining battery life, or the like.

The hazard triangle 20 may also include an actuation mechanism that in this example has a switch 62 provided to operate the hazard triangle, and more specifically, the light source. In this example, the switch 62 is positioned on or in the housing 90. The actuation mechanism may also employ a push button actuator 66 or other type of actuator to activate or operate the switch 62. In other examples, the push button actuator 66 may instead be a toggle actuator, a touch sensitive actuator, a slide actuator, or other suitable actuator or device. The switch 62 and push button actuator 66 are used to turn the LED's 50 ON and OFF. If desired or needed, the switch 62 may be configured to perform or affect other functions of the hazard triangle 20 as well.

The hazard triangle 20 can also include a processor or microprocessor 68 located within the housing 90. The microprocessor 68 can be programmed or configured to provide additional functionality for the hazard triangle 20. The microprocessor 68 can be designed to allow for dimming or adjusting the brightness of the illumination element, such as the LED or LED's 50. The microprocessor 68 and/or the charging chip 58 can be designed to allow for controlling energy usage of the battery 56 to preserve battery life under specific circumstances. The microprocessor 68, and/or the charging chip 58, can be designed to provide a timer function to turn OFF the illumination element or the light source after a specified time period. The hazard triangle 20 can have a motion sensor (not shown) that is coupled to the microprocessor 68, whereby the illumination element or light source is automatically turned on or off when the hazard triangle is picked up or is not being used.

The hazard triangle 20 can also include a small user display or touch screen (not shown) for the user to view certain operation parameters of the hazard triangle such as ON/OFF status, battery life, brightness, timer data, and the like. Such a display or screen can be provided on the exterior surface housing 90 or can be provided on another part of the hazard triangle 20. Such a display or screen can also be connected to the microprocessor 68 whereby each may control functions of the other. Alternatively, or in addition, the hazard triangle 20 can include a power ON/OFF indicator, such as a power LED or light 70 that is visible on the housing 90, the push button actuator 66, or another part of the hazard triangle. Further, the hazard triangle 20 can include a battery charge indicator, such as a charging LED or light 72 that is also visible on the housing 90, the push button actuator 66, or the hazard triangle. The hazard triangle 20 may include a separate panic button (not shown) that, when pressed, can sound an alarm. The panic button can also be controlled and/or operated by the microprocessor 68.

The hazard triangle 20 may also include a circuit board 74 to which the various components are connected or attached. The switch 62, push button actuator 66, battery 56, charging chip 58, USB port 60, other components of the power source 54, the ON/OFF and charging indicators 70, 72, and the LED's 50 can be connected to the circuit board 74 and thus to one another via the board, as is known in the art. Wires may be used to connect the various components to the circuit board 74. Electrical contacts can be provided as well between the various components and the circuit board 74. The microprocessor 68 can also be carried on the circuit board 74 or be connected thereto as well. The functional design of these components can vary considerably within the spirit and scope of the present invention.

Referring to FIGS. 3 and 4, the hazard triangle 120 is configured differently in comparison to the hazard triangle 20. In this example, the hazard triangle 120 has two of the housings 90, one disposed at or near each of the bottom corners 32 of the body 130. The hazard triangle also includes two curved notches 145, one at or near each bottom corner 32, to accommodate a respective one of the housings 90. Otherwise, the details and function of the two housings 90 may be same as that described above. In this example, each of the housings 90 carries an illumination element or light source, which emits light into the corresponding curved notch 145. Each housing 90 can be positioned and configured to emit light for the portion of the body between the respective side edge 38 or 40 and the inner edge 133 of the central opening 131 in the body. Further, in this example, the slot 124 in the support stands 122 is wider to accommodate the width of the housings 90, as the stands are coupled to the body 130 through the housings, not directly to the proximal edge 44.

Referring to FIGS. 1, 2, 5, and 6, emitted light from the LED's 50 entering the body 30 at the curved notch 45 of the proximal edge 44 will propagate within and along the body. Light will then be emitted by, i.e., exit the body 30 over the front and rear surfaces 34, 36 and via the side edges 38, 40 of the body. The emitted light exiting the body 30 may otherwise concentrate nearer the proximal edge 44 without fabricating the body 30 to propagate the emitted light along the body to distribute the light more evenly over the surfaces of the body. The body 30 can thus be fabricated from a high grade, expensive material or can otherwise be modified to add surface effects to the body. The material and its thickness can be specifically designed and tuned to allow light to exit the various surfaces only upon hitting the surfaces from within the body at specific angles. Such a hazard triangle might be relatively expensive.

In the disclosed examples, the body 30 may instead (or in addition) be modified to better distribute emitted light over the surfaces of the body. For example, referring to FIGS. 1, 2, and 6, the front and rear surfaces 34, 36 can each include an applique, i.e., an additional layer 80 of material that is opaque, translucent, or semitransparent to light so that all light does not pass cleanly through the material but that at least some propagating light is instead reflected back into the body 30 and/or absorbed by the material. The hazard triangle 20 may be constructed so that light is directed from the body 30 during use at specific angles or in one or more specific directions. For example, the emitted light can be described as “omnidirectional.”

The appliques or layers 80 of material can be created to match the shape of all or part of the shape of the body 30. The appliques or layers 80 of material to be applied may be translucent or semi-transparent. In one example, referring to FIGS. 1, 2, and 6, the applique or layer 80 may be a Diamond Grade Reflective Fluorescent Orange material, which is produced by Minnesota Mining & Manufacturing (3M). The material may be highly suitable for the disclosed hazard triangle 20 because the material permits light to pass though the layer 80 and very evenly distributes the emitted light from within the body 30. The material is also highly reflective of light hitting the surface of the layer 80 on the body 30 from outside the hazard triangle 20. The hazard triangle 20 in this example is particularly well suited for day and night time use. As shown in FIG. 6, the 3M applique or layer 80 may be applied to the front surface 34, rear surface 36, the side edge 38, and the side edge 40.

The orange or other color can be selected so that the hazard triangles 20 are also highly visible during the day and at night. The material layer 80 can be formed of any suitable material, such as vinyl, PVC, or the like. The material layer 80 may also be formed of materials that are moisture resistant, UV resistant, temperature resistant, and may also include fluorescent or luminescent, i.e., phosphorescent qualities. The material layer 80 can include an adhesive backing to easily adhere the layer to the body 30. However, the material layer 80 could be attached to the hazard portion using other suitable methods and materials. Further, the material layer 80 could be applied only on the front surface 34, only on the rear surface 36, only on some or all of the exposed side edges 38, 40, or on any combination thereof. Also, the side edges 38, 40 can be modified to block all light from being transmitted therethrough, to permit any light hitting the side edges to readily be transmitted therethrough, or to permit only a desired proportion of light to be transmitted therethrough.

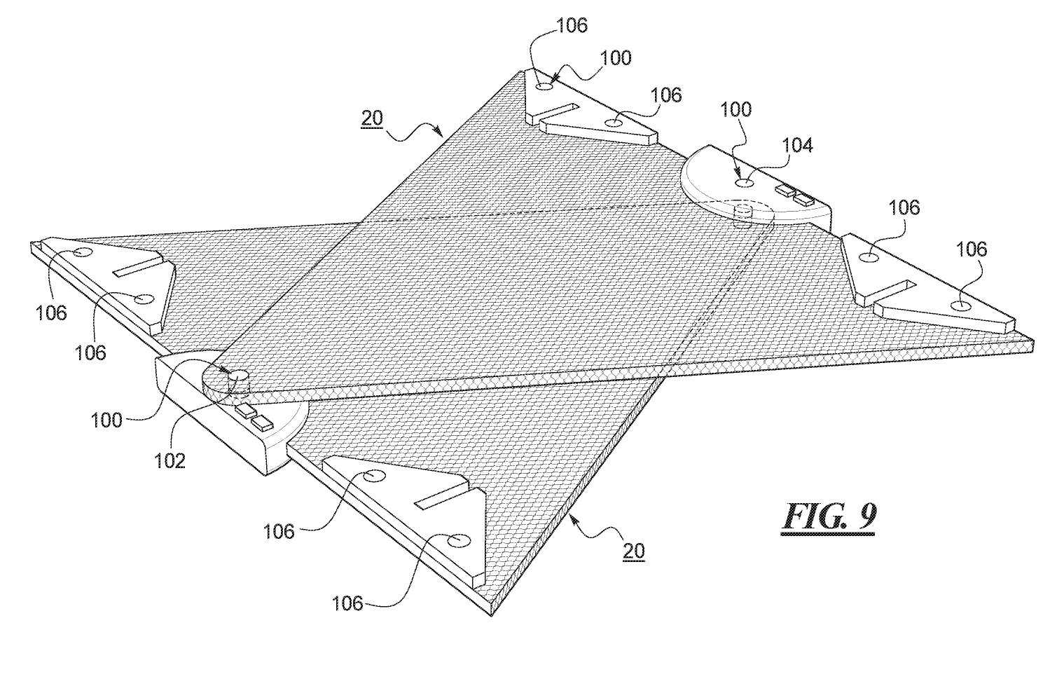

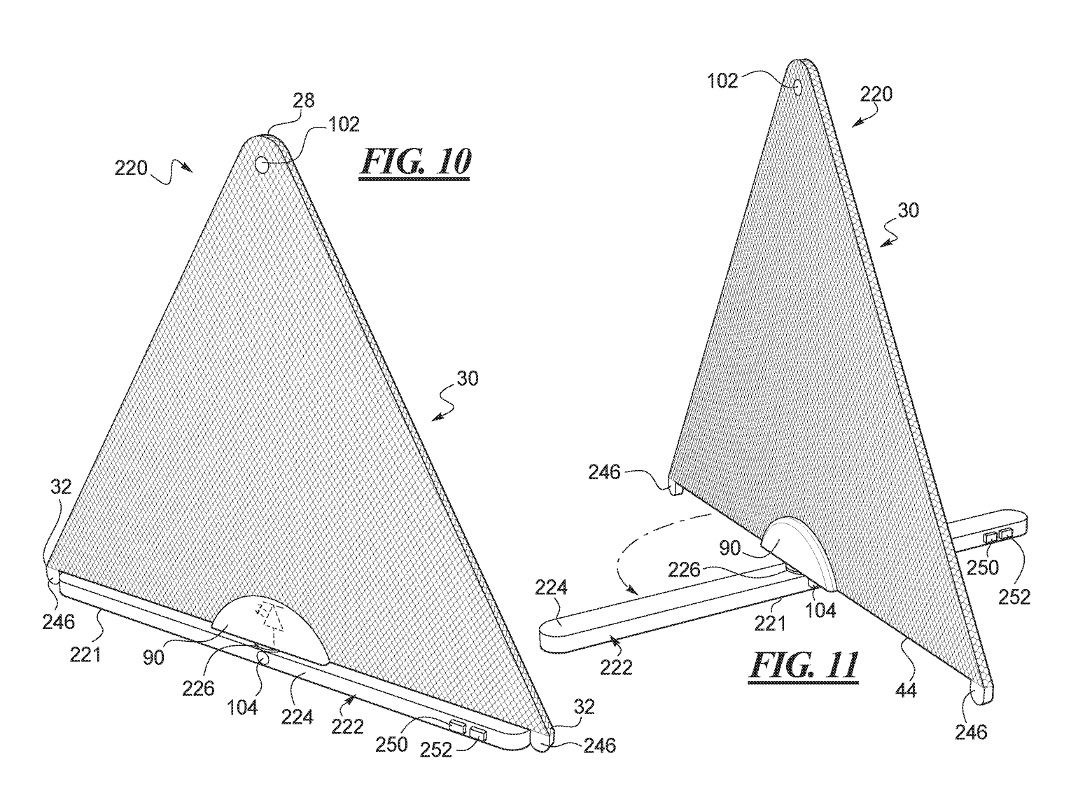

Referring to FIGS. 7 and 8, the disclosed hazard triangles 20, 120 may have a body of an alternative construction. In the prior examples, the bodies 30 and 130 were formed of a solid piece of material having a single unitary layer. However, the hazard triangle 20, 120 can instead include a body 150 that includes a plurality of material layers that are joined together to form a slid body. Alternatively, the body can be a hollow structure (not shown) with an open interior space between the various side edges 38, 40, the proximal edge 44, and the front and rear surfaces 34, 36. In the example of FIG. 6, the body 150 is constructed of multiple layers, i.e., two layers 152 and 154 in this specific example. The layers 152, 154 each may have an internal facing surface 156 that is textured in a manner to provide patterns of different, predetermined surface features. The surface features of the surfaces 156 may be configured to transmit, reflect, block, refract, or redirect light in different ways to produce desired light emitting effects. The surface features could be molded into the surfaces or could be formed into the surfaces by blasting, cutting, mechanical etching, laser etching, engraving, or the like. The layers 152, 154 then may be joined together, as shown in FIG. 8, with the textured surfaces 156 facing one another or confronting one another within the body 150. The layers 152, 154 can be joined to one another along a joint or seam 158 by ultrasonic welding, heat welding, use of an adhesive compound, or by other suitable processes.

In another example (not shown), the exposed surfaces of the body 30 or 130 may be textured to provide patterns of different surface features, which may be configured to transmit, reflect, block, refract, or redirect light in different ways to produce desired light emitting effects. Such surface textures can be formed using any known techniques suitable for the specific material of the triangle portion. The surface textures could be molded into the surfaces or could be formed into the surfaces by blasting, cutting, engraving, mechanical etching, laser etching, or the like. Likewise, the surface textures can be formed only on the front surface, only on the rear surface, only on some or all of the exposed side edges, or on any combination thereof. Such surface textures may also be formed on some or all of the exposed side edges. In still another example, similar features may be formed within the interior of the material of the body, between the front and rear surfaces, from an external process, if desired.

In yet another example, instead of an applique layer, the surfaces of the body portion may be painted or coated with a colored material layer. The paint or coating on the body can give the hazard triangle a highly visible hue, such as bright or fluorescent orange, both during day when not illuminated and at night when illuminated. The paint or coating can also include a luminescent or phosphorescent characteristic. Also, the paint or coating may either be a thinner or thicker coating nearer the proximal edge 44 and/or may have a different color nearer the proximal edge than that of the distal segment.

The disclosed hazard triangles may also be configured to include additional features to enhance or accommodate storage, handling, and the like. Referring to FIG. 9, the body 30 and support stands 22 of the hazard triangle 20 can be fitted with a magnetic feature 100 having magnetic components or elements. The magnetic feature may be employed to adhere the support stands 22 flat to a surface of the body 30 and to adhere two (or more) of the hazard triangles 20 together. The magnetic feature 100 may be used to connect two or more of the hazard triangles 20 together in a stored or storage configuration for storage. The magnetic feature may also be used to magnetically attach the hazard triangle 20 or two or more stacked and stored hazard triangles to a metallic surface for storage.

In this example, each hazard triangle 20 may include a first magnet or ferrous element 102 on or embedded in a portion of the hazard triangle at one end, such as near the top corner 28 of the body. Each hazard triangle 20 may also include a second magnet or ferrous element 104 at another end, such as near the center of the proximal edge 44. In this example, the second magnetic element 104 is positioned on the single, housing 90, which is positioned in the middle of the proximal edge. The magnet or ferrous element 102 on the one hazard triangle 20 is magnetically attractive to a magnet or ferrous element 104 on another hazard triangle. Likewise, each of the support plates 25 of the support stands can include one or more magnets or ferrous elements 106. The body 30 can include corresponding numbers of magnets or ferrous elements 108 in a desired position. In this example, the magnets or ferrous elements 108 are located near the proximal edge 44 and adjacent the bottom corners 32. The magnet or ferrous elements 106 on the support stands 22 are magnetically attractive to the magnets or ferrous elements 108 on the body. In this way, as shown in FIG. 9, the support stands 22 can be removed from the body 30 and attached and stored flat to the front or rear surface 34, 36 of the body and two hazard triangles 20 can be easily attached to one another, rotated 180 degrees opposite one another, for storage. The two attached hazard triangles 20 can then be stored together on a surface.

FIGS. 10-12 show another example of a hazard triangle 220 constructed in accordance with the teachings of the present disclosure. In this example, the hazard triangle 220 has a body 30 with a top corner 28 and two bottom corners 32, a housing 90, and magnetically attractive elements 102, 104 of a magnetic storage feature 100, similar to the hazard triangle 20. However, the support stands 22 are replaced in this example with a lone support stand 222. The support stand 222 has an elongate bar 224 that is attached to the proximal edge 44 (or the housing 90 as in this example) of the hazard triangle 220 at a pivot axis 226. The support stand 222 also has a pair of feet 246 that protrude downward from or near the respective bottom corners 32. The bar 224 lies between the feet and adjacent and parallel to the proximal edge 44 in the stored configuration of FIG. 10.

The bar of the support stand 222 can be configured to rotate about the pivot axis 226 in order to easily change the hazard triangle 220 from a storage configuration or position, as shown in FIG. 10, to a standing configuration or position, as shown in FIG. 11. The bar 224 can rotate to the standing position in which the bar is non-parallel relative to the proximal edge 44. In one example, the bar 224 can be oriented perpendicular to the proximal edge 44, as depicted in FIG. 11, in the standing configuration of position. The combination of the bar 224 and the feet 246 can support and hold the hazard triangle 220 in an upright orientation, as shown in FIG. 11, in the stand configuration. The size, shape, and configuration of the bar 224 of the support stand 222 and the feet 46 can vary from the disclosed example illustrated in FIGS. 10-12.

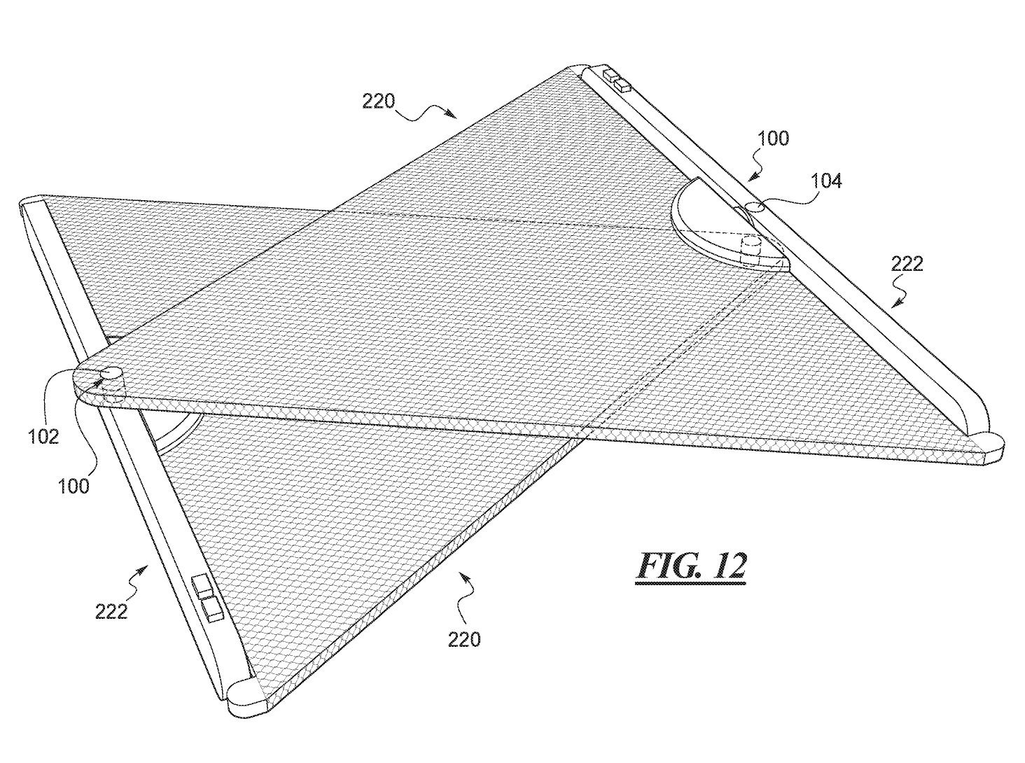

As shown in FIG. 12, two of the hazard triangles 220 can be easily stored and attached to one another via the magnetic feature 100, which can include the magnetic or ferrous elements 102, 104 on the bodies 30 and on the bars 224. The feet 246 and bar 224 of the stand support 222 can also be formed of any suitable material or combinations of materials. For example, the bar 224 can be made from inexpensive plastic materials, rubber materials, or combinations thereof. A bottom surface 221 of the bar 224 can include a texture to improve friction, if desired. Alternatively, the bar 224 can be formed having a substantially rigid inner structure, such as a hard plastic material, covered by a softer outer layer. The bar 224 in this example also includes buttons 250, 252, which may be provided to control aspects of the hazard triangle 220, and more specifically, to control components of the housing 90, as described above.

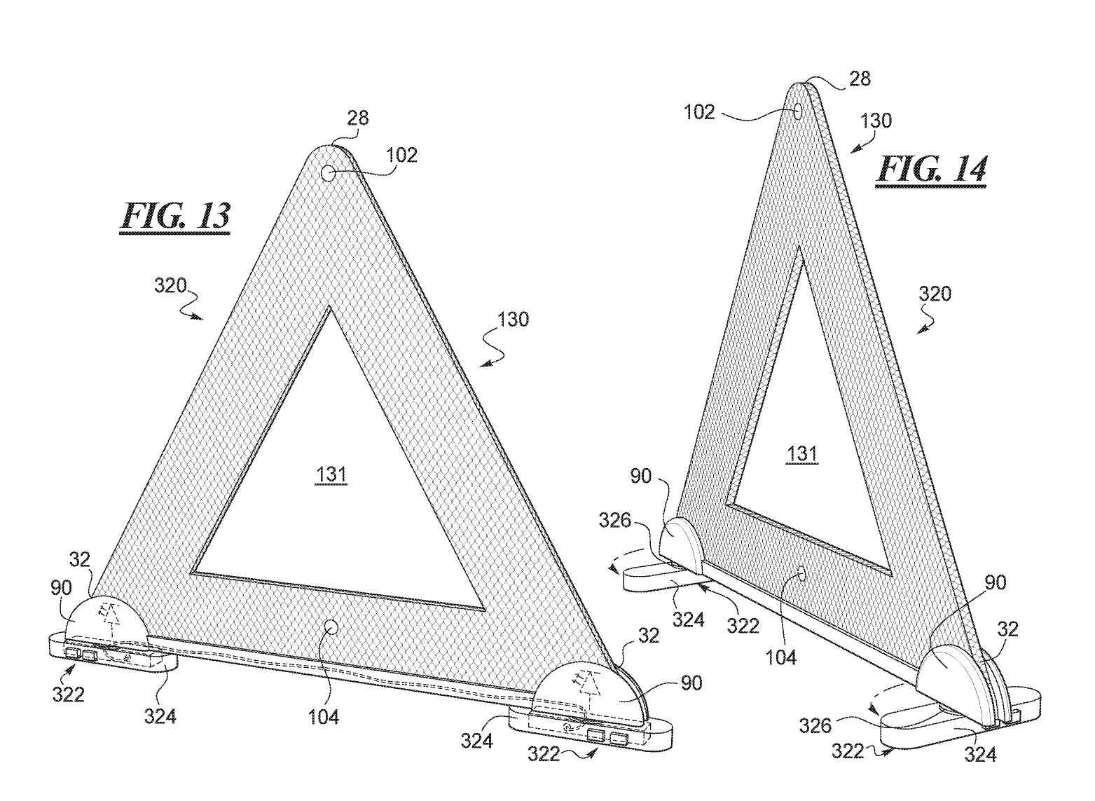

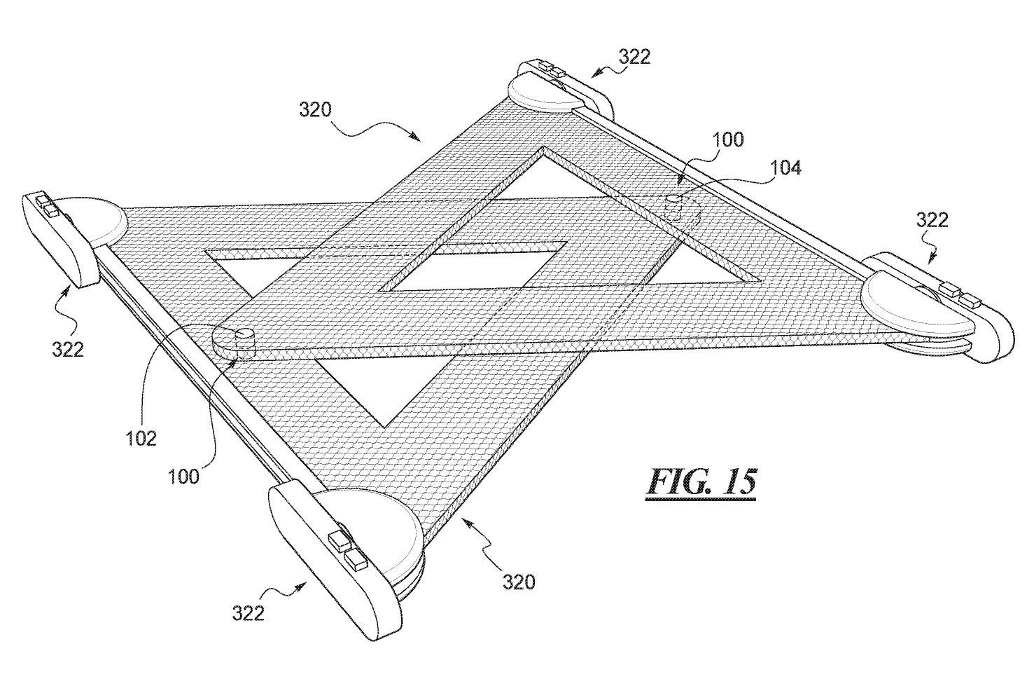

FIGS. 13-15 show another example of a hazard triangle 320 constructed in accordance with the teachings of the present disclosure. In this example, the hazard triangle 320 has a body 130 with a top corner 28 and two bottom corners 32, a pair of the housing 90, and magnetically attractive elements 102, 104 of a magnetic storage feature 100, similar to the hazard triangle 120. However, the support stands 122 are replaced in this example with a pair of the swiveling support stands 322, one coupled to each of the housings 90. The support stands 322 are otherwise substantially similar to the support stand 222 of the preceding hazard triangle 220. The only substantial difference is that the support stands 322 have much shorter bars 324 and the support stands 322 have no feet 246 protruding from the body 130. In this example, each swivel support stand 322 is pivotable about its own pivot axis 326. The swivel support stands 322 can be configured to rotate about their respective axes 326 in order to easily change the hazard triangle 320 from a storage configuration or position, as shown in FIG. 13, to a standing configuration or position, as shown in FIG. 14. The swivel support stands 322 cooperate to support and hold the hazard triangle 320 upright, as shown in FIG. 14. As shown in FIG. 15, the two hazard triangles 320 can also be easily stored and attached to one another via the magnetic feature 100.

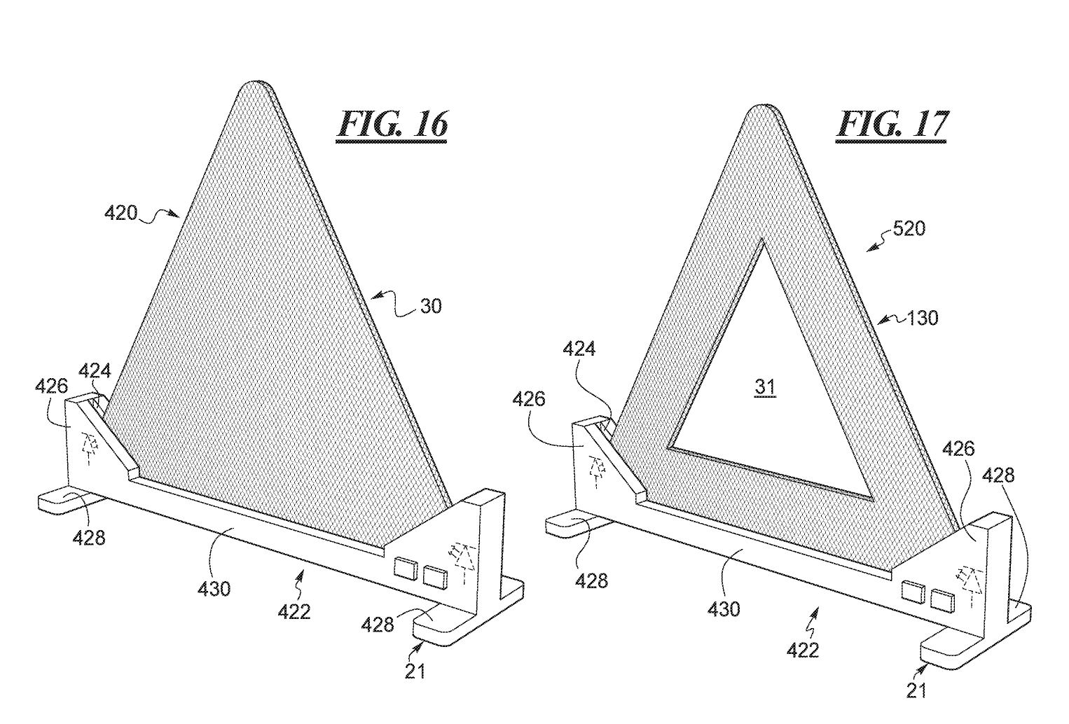

FIGS. 16 and 17 show two additional examples of hazard triangles 420 and 520, respectively, and each is constructed in accordance with the teachings of the present disclosure. The hazard triangle 420 has a support stand, i.e., a base 422 coupled to and supporting a body 30 that may be the same as the earlier described body of the hazard triangle 20. The base 422 houses the above described functional components of the housings 90 to operate the hazard triangle 420 and to provide additional functionality for the hazard triangle. The base 422 can act as and replace the housing 90 with the various components and features disposed within the base 422. The base 422 has a slot 424 that is configured to receive the proximal edge 44 of the body 30 and to support and hold the body of the hazard triangle 420 upright, as shown in FIG. 16. The size, shape, and configuration of the base 422 can vary from the disclosed example illustrated in FIG. 16. In this example, the base 422 has two corner portions 426 that can be sized to securely hold the body 30 upright and that can house any one or more of the various illumination and electronic components and features of the hazard triangle 420. The base 422 also has a pair of feet 428 that are oriented perpendicular to a main section 430 that extends parallel with the proximal edge 44 of the body. The base 422 can have any number of the feet 428 and the feet can vary in position, shape, and size, as desired.

The hazard triangle 520 of FIG. 17 has a support stand, i.e., a base 422 coupled to and supporting a body 130 that may be the same as the earlier described body of the hazard triangle 120. In this example, the base 422 of the hazard triangle 520 is the same as the base of the hazard triangle 420. In these example, the base 422 can also be formed of any suitable material or combinations of materials. For example, the base 422 can be made from inexpensive plastic materials, rubber materials, or combinations thereof. Bottom surfaces of eh feet 428 and/or the main section 430 of the base 422 can include a texture to improve friction, if desired. Alternatively, the base 422 can be formed having a substantially rigid inner structure, such as a hard plastic material, covered by a softer outer layer. In the examples of FIGS. 16 and 17, the base 422 can be easily removable from the bodies 30, 130, such as by magnetic connection, mechanical detents, simple latches, and the like or can be permanently attached thereto via adhesive, non-removable fasteners, welding, and the like. Further, the hazard triangles 420, 520 can also be magnetically attachable to like triangles for storage using a similar magnetic feature as described herein.

As will be evident to those having ordinary skill in the art, the shape of the body 30 and body 130 can vary from the examples disclosed herein. The triangle portion can be, for example, a triangle, a truncated triangle, rounded or sharp at the corners, rounded or sharp along the side edges, elliptical, or the like. The size of the hazard triangles can also vary within the spirit and scope of the disclosure.

As will be evident to those having ordinary skill in the art, the disclosed hazard triangles can vary from the examples shown and/or described herein. The body can be made from a clear plastic or a tinted material. The body can be made with a single layer or multiple layers. The size and shape of the body can be varied considerably depending on the particular application or use intended. The body and its surfaces can be modified to achieve desired light emitting effects. Component features and performance characteristics can also be altered or changed from the examples shown and/or described herein. The size, shape, type, location, and/or performance characteristics of the illumination element or light source, power source, battery, housing, body, switch, push button actuator, microprocessor, and/or the like can all vary considerably.

The disclosed hazard triangles have an illumination element configured to power a light source to illuminate the hazard triangle at night like the prior art noted above. However, the disclosed hazard triangles are more efficient and much simpler to service and repair due to fewer illumination element components being needed to illuminate the hazard triangle at night. In addition, the hazard triangles disclosed herein may be smaller and lighter without giving up any performance benefits of prior known illuminated hazard triangles. The magnetic components of the hazard triangles also allow two or more of the triangles to be mated flat and/or parallel together, but rotated 180 degrees relative to one another or otherwise appropriately misaligned with one another. The two or more hazard triangles can then easily be stored in a single carrier.

Although certain hazard triangles and components, features, and characteristics have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A hazard triangle comprising:
a body having a triangular shape formed of a transparent or semi-transparent material with a thickness and three sides, one of the three sides defining a proximal edge, the thickness being substantially less than a length of any one of the three sides; and
an illumination element configured to emit light into the proximal edge of the three sides,
wherein the emitted light is propagated by the body such that the emitted light is emitted from surfaces of the body other than the proximal edge.

2. A hazard triangle according to claim 1, further comprising a power source disposed within a housing.

3. A hazard triangle according to claim 2, wherein the power source includes a rechargeable battery disposed within the housing.

4. A hazard triangle according to claim 1, wherein the illumination element is located near at least one corner of the body on the proximal edge.

5. A hazard triangle according to claim 4, wherein the illumination element includes two light sources, one of the two light sources located near a different corner of the body on the proximal edge.

6. A hazard triangle according to claim 1, wherein the illumination element includes a LED as a light source.

7. A hazard triangle according to claim 1, wherein the illumination element is adjacent the proximal edge, and wherein a portion of the proximal edge is curved concavely relative to the illumination element to direct the emitted light from the illumination element in a plurality of directions into the body.

8. A hazard triangle according to claim 7, wherein the illumination element includes a lens disposed between the portion of the proximal edge and a light source of the illumination element, the lens being concave relative to the light source.

9. A hazard triangle according to claim 1, further comprising a switch disposed within a housing, the switch configured to operate the illumination element.

10. A hazard triangle according to claim 9, wherein the switch is coupled to an actuator that is exposed to an exterior surface of the housing.

11. A hazard triangle according to claim 1, wherein the body is formed of a solid acrylic material.

12. A hazard triangle according to claim 1, further comprising a microprocessor disposed within a housing, the illumination element operably connected to the microprocessor.

13. A hazard triangle according to claim 1, wherein at least a front surface and a rear surface of the body are modified to control an amount of the emitted light emitted therefrom, a direction of the emitted light emitted therefrom, or both the amount and the direction of the emitted light emitted therefrom.

14. A hazard triangle according to claim 13, wherein two sides of the three sides of the body, other than the proximal edge, are modified to control the amount of the emitted light emitted therefrom, the direction of the emitted light emitted therefrom, or both the amount and the direction of the emitted light emitted therefrom.

15. A hazard triangle according to claim 13, wherein an applique layer of material is applied to the front surface and the rear surface of the body, the applique layer configured to omnidirectionally disperse the emitted light emitted therefrom.

16. A hazard triangle according to claim 15, wherein the applique layer is 3M Diamond Grade Reflective Fluorescent Orange material adhered to the body.

17. A hazard triangle according to claim 13, wherein an applique layer, coating, or surface texture is applied to at least a portion of the front surface and the rear surface of the body.

18. A hazard triangle according to claim 1, wherein the body is formed of two layers of material joined to one another, wherein a surface of each of the two layers is etched, and wherein the etched surfaces face one another within the body.

19. A hazard triangle according to claim 1, wherein at least one support stand is coupled to the proximal edge of the body.

20. A hazard triangle according to claim 1, wherein at least one support stand is coupled to the body and can rotate about an axis between a stored position generally parallel with the body and a support position not parallel with the body and configured to hold the body upright.

21. A hazard triangle according to claim 1, wherein at least one support stand is coupled to the body and configured to hold the body upright, the support stand having a slot in which the proximal edge of the body is received.

22. A hazard triangle according to claim 21, wherein the illumination element is housed within a portion of the support stand.

23. A hazard triangle according to claim 1, further comprising:
a microprocessor disposed within a housing coupled to the body, the microprocessor configured to control one or more functions of the hazard triangle;
a USB port carried by the housing;
a charging chip disposed within the housing;
a rechargeable battery disposed within the housing, the charging chip configured to control at least one aspect of recharging the rechargeable battery, the USB port configured to connect to a source of power to recharge the rechargeable battery;
an actuation mechanism disposed at least in part within the housing, the actuation mechanism configured to control the illumination element; and
a lens disposed between a light source of the illumination element and a portion of the proximal edge of the body.

24. A hazard triangle according to claim 1, further comprising a magnetic element configured to magnetically adhere the hazard triangle to a second hazard triangle of like construction.

25. A hazard triangle according to claim 1, wherein the body has a central triangular opening disposed inward of the three sides.

26. A signaling device comprising:
a body formed of a transparent or semi-transparent material with a thickness and a perimeter, a portion of the perimeter defining a proximal edge; and
an illumination element configured to emit light into the proximal edge of the perimeter,
wherein the emitted light is propagated by the body such that the emitted light is emitted from surfaces of the body other than the proximal edge.
